(19) United States
(12) Patent Application Publication
(10) Pub. No.: US 2007/0008098 A1
(43) Pub. Date: Jan. 11, 2007

(54) Method and architecture for online classification-based intrusion alert correlation

(76) Inventor: Hsing-Kuo Wong, Lung-Tan Township (TW)

Correspondence Address: J C PATENTS, INC., 4 VENTURE, SUITE 250, IRVINE, CA, 92618, US

(21) Appl. No.: 11/177,803

(22) Filed: Jul. 8, 2005

(51) Int. Cl. G08B 29/00

(52) U.S. Cl. 340/506

(57) ABSTRACT

A method and architecture for on-line classification-based intrusion alert correlation are provided. This method applies layered architecture to split and correlate alerts. An alert-splitting technique is used to separate mostly general alerts from more valuable or complicated alerts. Only more important alerts are selected to correlate with known attack scenarios to discover important attack information. Therefore, the disadvantages in the prior art where correlation is shielded and over-consumption of computation resource are solved.

### BACKGROUND OF THE INVENTION

1. Field of the Invention

This invention generally relates to a method for alert processing, and especially to a method for classification-based intrusion alert correlation.

2. Description of Related Art

Intrusion alert (hereinafter as alert) correlation is a process of identifying alerts belonging to a same intrusion scenario, to represent a network attack with a clear, high-level and global view for an administrator in a security operation center. Through the information security incidents (hereinafter as incidents) obtained by alert correlation, an administrator is able to understand and monitor an important large-scale network attack occurred in his administrative domain, and contain the ongoing network attacks and to recover the damage and prevent following attacks.

Since a security operation center usually receives a huge amount of alerts which exceed what administrators can handle and also go beyond the capacity of common process tools, it is necessary that a security operation center adopts alert correlation to discover an important or large-scale network attack from a huge amount of alerts, for forming an incident as a reference for administrators.

Take a DDOS attack as an example. When a hacker launches a DDOS attack against a target, multiple steps are performed such as scanning a network first to look for vulnerability in a host, planting a backdoor program in multiple hosts through the discovered vulnerability, and attacking the target together by remotely commanding the backdoor programs. During the DDOS attack, the intrusion detection systems (IDS systems) deployed at an administrative domain can be triggered by various attack steps to generate various alerts, which are received by a security operation center. The security operation center will correlate the received alerts, detect the scope which was scanned, track the hosts which the backdoor program is planted and the target which is attacked, and form a DDOS attack incident for the administrator.

The typical alert correlation can be classified as two approaches:

1. The attack scenario-oriented approach, which bases on known network attacks to design an attack scenario to describe attack steps and their relationship. When performing an alert correlation, alerts are correlated according to the attack steps and relationship of a scenario.

2. The cause-effect-oriented approach, which bases on each alert to determine its pre-conditions and post-conditions. When performing an alert correlation, the pre-conditions of a received alert are used to search for the post-conditions of previous alerts. If two conditions are matching, it means that they have a cause-effect relationship and therefore can be correlated.

Currently, the information security-related industry mainly utilizes attack scenario-oriented approach to perform alert correlation, and cause-effect-oriented approach is under research in academic fields.

Since the purpose of alert correlation is to detect important or/and large-scale network attacks for forming an incident as a reference for administrators, the alert correlation must be processed online in time. For any recently received alerts, it is possible one step of a subsequent attack, so the alert correlation must record its status and correlate it with previous relevant alerts. Due to the fact that the amount of alerts received by a security operation center is often very huge, the requirement of online in-time process is a substantial restriction for alert correlation.

Because of the inherent restriction, the alert correlation of the prior art has the following problems and disadvantages:

1. The method and architecture of alert correlation lacks flexibility and efficiency. The purpose of alert correlation is to group and associate attack steps through received alerts to discover an attack scenario and detect an incident. Although any of alerts generated by an IDS system are possible one step of an upcoming or ongoing network attack, in the view of scenario reorganization, each alert can be viewed as one of clues provided by front-end IDS systems, and each clue has different value. The clue that can directly prove a network attack should own a higher value, whereas general or uncertain clues are only some referential evidence for the lead, therefore alerts should be correlated with the basis of classification of alert importance. However, current alert correlation method and architecture lacks such discrimination and regard all alerts as equals. The lack of flexibility would eventually bring down the overall efficiency.

2. A large amount of incomplete incidents waste computational resources. Because network scanning is usually one previous step of a large-scale attack, which is very likely related with other attacks, thus whether the attack scenario-oriented approach or the cause-effect-oriented approach is used for alert correlation, scanning alerts must be recorded. The characteristic of scanning alerts is their large amount and high output frequency, as shown in FIG. 1, which schematically shows a statistic comparison between scanning alerts with all alerts. From the respect of alert volume, the scanning alerts are obviously major. Network scanning is usually an attacker's act of field search, and most scanning alerts do not have a cause-effect relationship with upcoming alerts. Since current alert correlation methods and architecture of the prior art lack the discrimination for alerts, a lot of correlation process with scanning alerts would failed and then become incomplete incidents, and computational resources for processing them are wasted for a security operation center.

3. Risk caused by floods of incomplete incidents. As the above mentioned, scanning alerts often come in a great amount and are frequently generated, which would take up computational resources of a security operation center, causing a new vulnerability to an alert correlation. For an attacker of ordinary skill in the art, a huge amount of scanning alerts can be triggered on the Internet to exploit this vulnerability. Thus a new type of DDOS attack, the incomplete incidents flood, is formed.

### SUMMARY OF THE INVENTION

An objective of the present invention is to provide a method for on-line classification-based intrusion alert correlation, wherein an alert-splitting technology is utilized to separate alerts provided by a front-end IDS system into a majority of general alerts and more valuable or complicated alerts to be separately processed. The general alerts are not used for scenarios correlation in order to improve the disadvantages of the prior art of alert correlation approaches.

Another objective of the present invention is to provide architecture for on-line classification-based intrusion alert correlation, wherein the alert correlation is processed with layers, a bottom layer being a situation layer, and an upper layer being a scenario layer. By utilizing the alert-splitting technology, general alerts, which are the majority, are placed at situation layers to be processed, whereas more valuable or complicated alerts are dispatched to a scenario layer. The results of bottom layers is provided to the upper layer for reference, therefore achieving the purpose of layer processing, where alerts are processed with layers and important alerts are correlated with priority.

The present invention provides a method for on-line classification-based intrusion alert correlation. First, a plurality of alerts is split into a plurality of situation alerts and a plurality of non-situation alerts. Then situation alerts matching any one of a fan-in situation, a fan-out situation and a focusing situation are correlated as a situation-intensive incident, and remaining situation alerts are classified as residual alerts. Furthermore, the non-situation alerts which match non-situation attack scenario are correlated as a plurality of semi-incidents. Finally the semi-incidents, the situation-intensive incidents and the residual alerts are correlated together, and an incident is formed if that correlation is successful.

In accordance with the method for on-line classification-based intrusion alert correlation in the embodiments of the present invention, situation alerts include scanning alerts, flooding alerts and continuous attack alerts.

In accordance with the method for on-line classification-based intrusion alert correlation in the embodiments of the present invention, the condition of fan-in situation is that among situation alerts with the same target and effect, the amount of distinct sources and the amount of alerts are all over their respective thresholds within a sliding window of time.

In accordance with the method for on-line classification-based intrusion alert correlation in the embodiments of the present invention, the condition of fan-out situation is that among situation alerts with the same source and effect, the amount of distinct targets and the amount of alerts are all over their respective thresholds within a sliding window of time.

In accordance with the method for on-line classification-based intrusion alert correlation in the embodiments of the present invention, the condition of focusing situation is that among situation alerts with the same source, target and effect, the amount of alerts are all over a specific thresholds within a sliding window of time.

In accordance with the method for on-line classification-based intrusion alert correlation in the embodiments of the present invention, a non-situation attack scenario is a known attack scenario with its situation steps marked as delay correlation.

The present invention provides the architecture for on-line classification-based intrusion alert correlation, comprising a situation layer for splitting a plurality of alerts into a plurality of situation alerts and a plurality of non-situation alerts; and a scenario layer, for saving a plurality of situation correlation results of situation alerts in a situation layer and non-situation alerts, further correlating the non-situation alerts based on a same non-situation attack scenario as a same semi-incident, and then correlating the resulted semi-incident with the situation correlation results as an incident.

In accordance with the architecture for on-line classification-based intrusion alert correlation in the embodiments of the present invention, a situation layer at least comprises a splitting device, for splitting alerts as a plurality of situation alerts and a plurality of non-situation alerts, and transmitting the non-situation alerts to a scenario layer; and a situation correlation engine, for correlating the situation alerts matching one of a same fan-in situation, a fan-out situation and focusing situation, as a same situation-intensive incident, and classifying the remaining situation alerts to residual alerts, and transmitting the situation-intensive incident and the residual alerts to the scenario layer.

In accordance with the architecture for on-line classification-based intrusion alert correlation in the embodiments of the present invention, a scenario layer at least comprises a plurality of non-situation attack scenarios, wherein each of non-situation attack scenarios describes a non-situation step of a known attack scenario as a reference of correlating a semi-incident; and a scenario correlation engine, for correlating the non-situation alerts matching a same non-situation scenario as a same semi-incident, further correlating the resulted semi-incident with the received situation-intensive incident and the residual alerts to form an incident if that correlation is successful.

In accordance with the architecture for on-line classification-based intrusion alert correlation in the embodiments of the present invention, a situation layer further comprises a filter, for filtering a plurality of unrelated alerts and incomplete alerts; and an aggregating device, for aggregating a plurality of similar alerts which are received within a short time duration as an alert.

In accordance with the architecture for on-line classification-based intrusion alert correlation in the embodiments of the present invention, if a situation layer is replaced by a plurality of situation layers, the relationships at least comprise that non-situation alerts formed by the splitting device of each of situation layers are sent to a same scenario layer, and that the situation-intensive incident and the residual alerts resulted by the situation correlation engine of each of situation layers are sent to a same scenario layer.

In accordance with the architecture for on-line classification-based intrusion alert correlation in the embodiments of the present invention, the deployment of a situation layer and a scenario layer at least comprises that one scenario layer and one situation layer are deployed at a same place, and the scenario layer is used as a security operation center, or a scenario layer is used as a security operation center, and situation layers are deployed at various locations.

The present invention utilizes the alert-splitting architecture, which filters and congregates the original alerts, only selects more important and complicated alerts to correlate with an attack scenarios to obtain important attack steps, and avoids correlating less important general alerts. Therefore, the disadvantages of prior art such as the huge consumption of computation resources, alert flood and incomplete incidents can be prevented.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 schematically shows a statistic table of scanning alerts and all alerts.

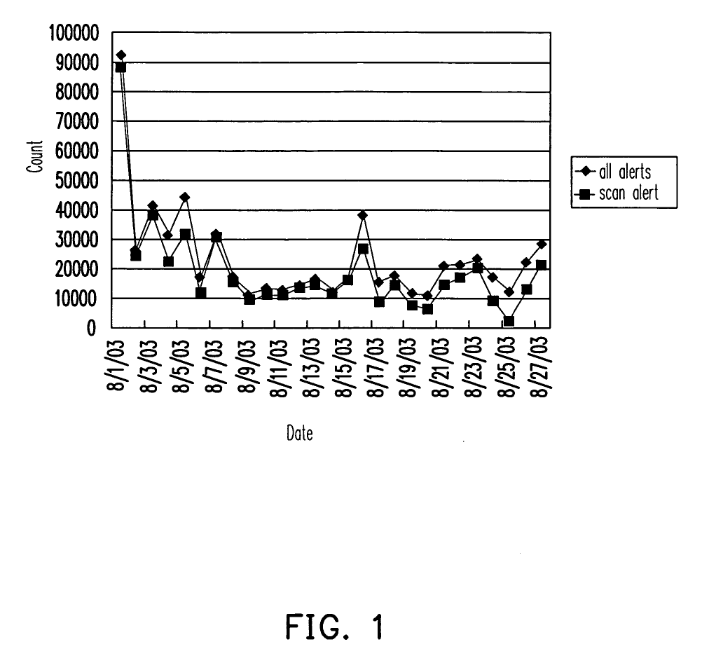

FIG. 2 schematically shows a flow chart of the method for online classification-based correlation according to an embodiment of the present invention.

FIG. 3 schematically shows a flow chart of a situation correlation process in the method for online classification-based correlation according to an embodiment of the present invention.

FIG. 4 schematically shows a flow chart of an extension process of the method for online classification-based correlation according to an embodiment of the present invention, wherein a pre-process is added.

FIG. 5 schematically shows architecture for online classification-based correlation according to an embodiment of the present invention.

FIG. 6 schematically shows extension architecture for online classification-based correlation according to an embodiment of the present invention, wherein a pre-process layer, a first database and a second database are added.

FIG. 7 schematically shows deployment architecture for online classification-based correlation according to an embodiment of the present invention.

FIG. 8 schematically shows a comparison of previous alert amount and improved alert amount according to an embodiment of the present invention.

FIG. 9 schematically shows the bar chart of comparison of previous alert amount and improved alert amount according to an embodiment of the present invention.

### DESCRIPTION OF THE EMBODIMENTS

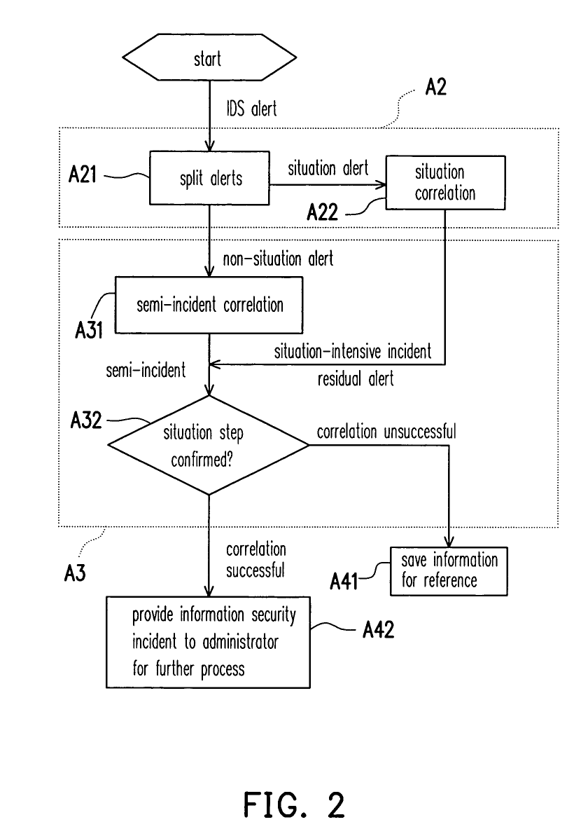

FIG. 2 schematically shows a flow chart of the method for online classification-based correlation according to an embodiment of the present invention. The method is mainly by correlating alerts with the awareness of situation so that situation alerts, which usually is the majority, and non-situation alerts are divided and correlated separately, further merging the initial correlation results of the two for reducing the correlation load of the prior art. The embodiment describes a process in which two types of classified alerts are correlated separately and further merged, including a procedure A2 of performing an alert-splitting and a situation correlation, and a procedure A3 of performing a non-situation correlation and further merging these two results.

First, as shown in step A21 of procedure A2, alerts that a security operation center received are split into situation alerts and non-situation alerts. Then, situation correlation is performed to the situation alerts shown in step A22 of procedure A2, and a semi-incident correlation is performed to the non-situation alerts shown in step A31 of procedure A3. Furthermore, the situation steps of the semi-incident are confirmed, as shown in step A32 of procedure A3. If the semi-incident does not need the situation steps or all the requisite situation steps exist, the correlation is successful and an incident is therefore created and provided to an administrator as shown in step A42; otherwise, the correlation is unsuccessful, and the information is saved for future reference as shown in step A41.

At the above-mentioned alert-splitting step A21, scanning alerts, flooding alerts and continuous attack alerts are classified as situation alerts, whereas other alerts are classified as non-situation alerts.

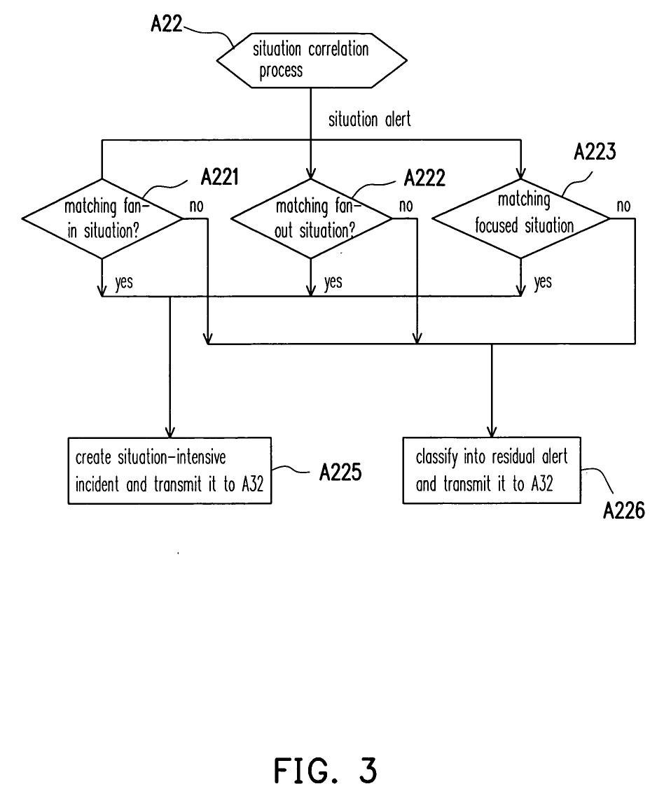

In the situation correlation step A22, the situation alerts matching condition of a fan-in situation, fan-out situation or focusing situation are correlated as a situation-intensive incident, and the remaining alerts are classified as residual alerts. Please refer to FIG. 3 for more details of step A22.

As shown in FIG. 3, step A221 is used to judge whether or not the condition of a fan-in situation is met, wherein the condition of a fan-in situation is that among the situation alerts with the same target and effect, the amount of distinct sources and the amount of alerts are all over their respective thresholds within a sliding window of time. In step A222, it is judged whether or not the condition of a fan-out situation is met, wherein the condition of fan-out situation is that among the situation alerts with the same source and effect, the amount of distinct targets and the amount of alerts are all over their respective thresholds within a sliding window of time. In step A223, it is judged whether or not the condition of a focusing situation is met, wherein the condition of focusing situation is that among the situation alerts with the same source, target and effect, the amount of alerts are all over a specific threshold within a sliding window of time. After evaluating the three situations in step A225, for the alerts matching one of situation conditions, a situation-intensive incident is created and is transmitted to step A32 in FIG. 2. In step A226, the alerts matching unsuccessfully are classified as residual alerts and are transmitted to step A32 in FIG. 2.

As shown in FIG. 3, all the three situation conditions are designed with parameters and flexibility, wherein the parameter target is one of destination IP address, destination port number, or a combination of destination IP address and destination port number, the parameter source is one of source IP address, source port number, and a combination of the source IP address and the source port number, and the situation alerts with the same effect are those with the same alert name and classified as the same scanning alerts, the same flooding alerts or the same continuous attack alerts. Above-mentioned parameters and thresholds can be pre-set by system or adjusted manually.

As shown in FIG. 2, a semi-incident is created to represent non-situation alerts that match a same non-situation attack scenario in step A31, wherein the non-situation attack scenario is a known attack scenario with its situation steps marked as delay correlation. For example, in an attack scenario of intruding a network, the intruder first scans the servers of a network, for obtaining an IP address of a host in the network. Then, the user list of the host is obtained by a null user inquiry, and the user's login password is obtained by a dictionary attack method. Here, the situation step—the network scanning—is marked as delay correlation, wherein the network scanning is ignored during correlating process, and only other steps are correlated. Therefore, a semi-incident is created if that correlation is successful.

The situation confirmation step A32 is by determining whether a semi-incident requires situation steps. If not, the correlation is complete and successful; if yes, it is required to confirm whether or not the marked delay correlation situation steps exist, and if they do exist, the correlation is complete and successful. An incident is created when the correlation is successful, meaning that an attack scenario is detected. In the previous example, the steps are to confirm whether or not the host of the intruded network is scanned.

In step A42, an incident is provided to an administrator if a correlation is successful, and in step A41, the information is saved for reference if the correlation is unsuccessful.

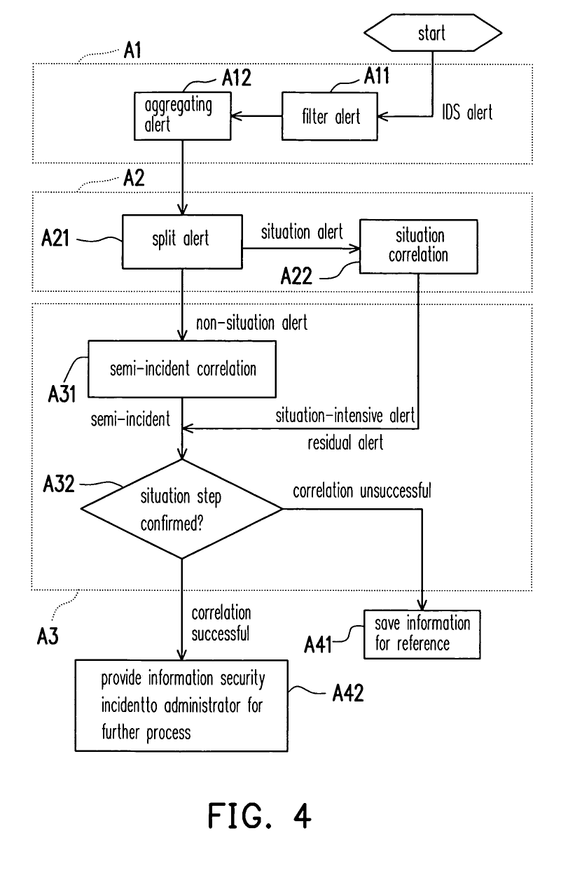

FIG. 4 schematically shows a flow chart of an extension process of the method for online classification-based correlation according to an embodiment of the present invention, wherein a pre-process method (procedure A1) can be accompanied with procedure A2, as the un-related alerts and the incomplete alerts are filtered in step A11, and in step A12, multiple similar alerts that are received in a short duration are aggregated as an alert, which is transmitted to step A21 of procedure A2 for further process.

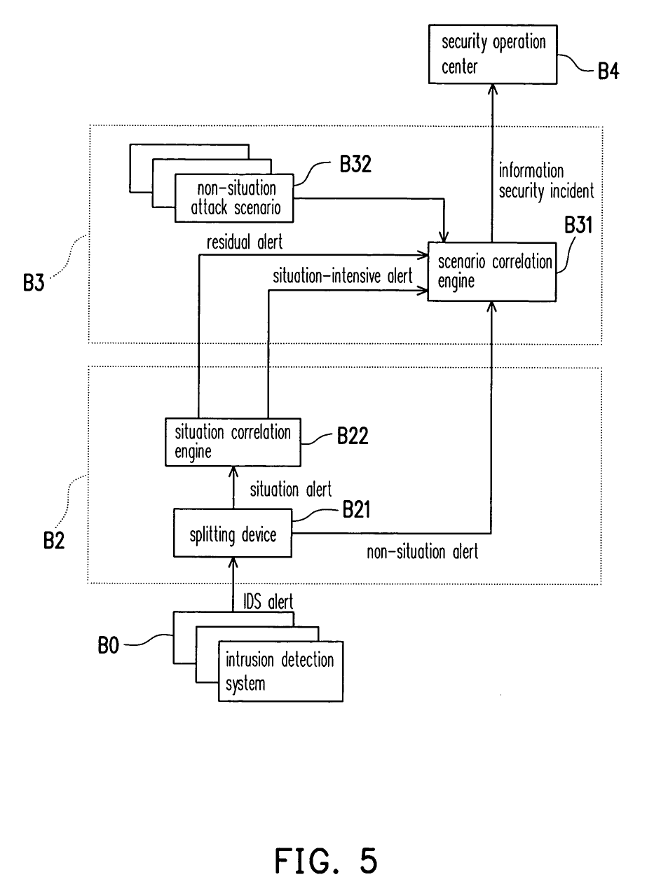

FIG. 5 schematically shows architecture for online classification-based intrusion alert correlation according to an embodiment of the present invention, wherein the correlation architecture includes a situation layer B2 and a scenario layer B3.

As shown in FIG. 5, situation layer B2 receives alerts provided by IDS system B0 deployed at various locations, and splits alerts into situation alerts and non-situation alerts, whereas scenario layer B3 saves the results of situation correlation of situation alerts in the situation layer and non-situation alerts, further correlates non-situation alerts matching a same non-situation attack scenario as a same semi-incident, which is further correlated the resulted semi-incident with the situation correlation results to form an incident. If the correlation is successful, scenario layer B3 transmits the incident to security operation center B4 for further process.

Situation layer B2 includes a splitting device B21 and a situation correlation engine B22. Splitting device B21 splits alerts of B0 into situation alerts and non-situation alerts, transmits the situation alerts to situation correlation engine B22, and transmits the non-situation alerts to scenario layer B3. Situation correlation engine B22 correlates the situation alerts matching one of a same fan-in situation, fan-out situation and focusing situation as a same situation-intensive incident, classifies the remaining situation alerts as residual alerts, and transmits the situation-intensive incident and the residual alerts to scenario layer B3.

Scenario layer B3 includes a scenario correlation engine B31 and a plurality of non-situation attack scenarios B32. Wherein, each of non-situation attack scenarios B32 describes non-situation steps of a known attack scenario as a reference of correlating a semi-incident. Further, scenario correlation engine B31 correlates the non-situation alerts matching a same non-situation attack scenario, B32, as a same semi-incident, and then correlates with the situation-intensive incident and the residual alerts received from B22, thus creating an information security incident if that correlation is successful.

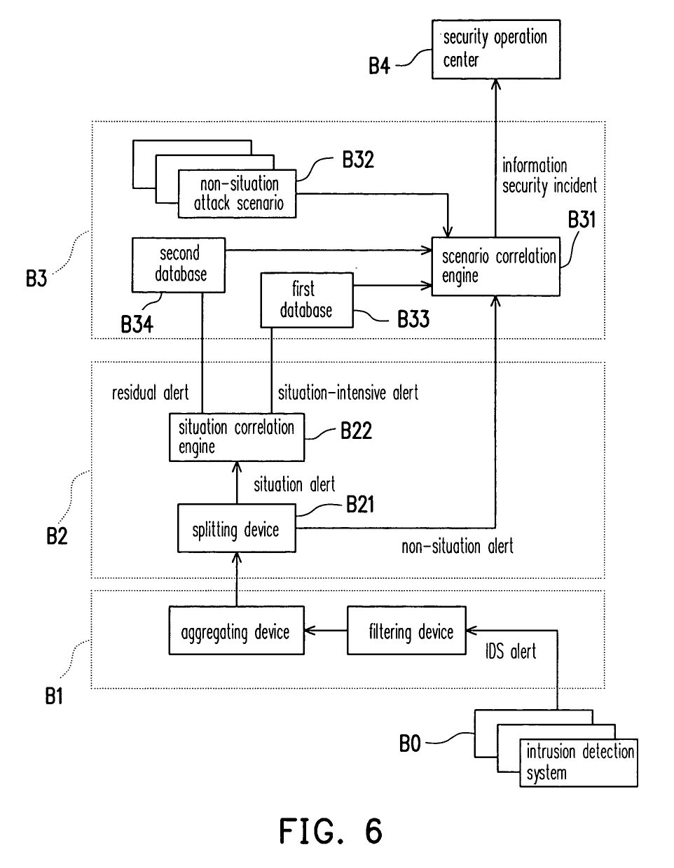

FIG. 6 schematically shows extension architecture for online classification-based correlation according to an embodiment of the present invention. The extension architecture includes adding a pre-process layer B1, a first database B33 and a second database B34 to scenario layer B3. Wherein pre-process layer B1 can be accompanied with situation layer B2 to filter un-related alerts and incomplete alerts by filter B 11, and aggregate a plurality of similar alerts highly concentrated within a time as an alert by aggregating device B12. Regarding the added databases, first database B33 saves the situation-intensive incidents transmitted from situation layer B2 and provides them to scenario correlation engine B31 for reference, for confirming whether or not the situation-intensive incidents are one of attack scenario situation steps. Second database B34 saves residual alerts from situation layer B2 and provides them to scenario correlation engine B31 for reference, for confirming whether or not the residual alerts are one of attack scenario situation steps.

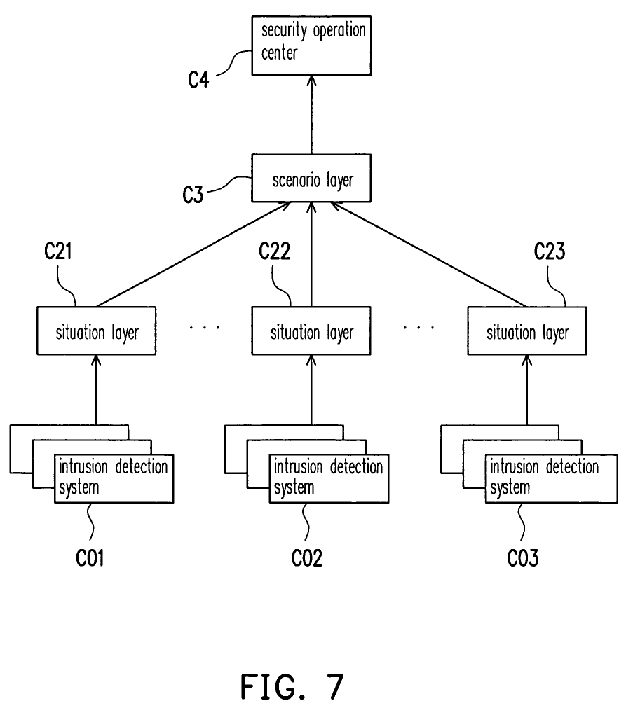

According to the above-mentioned architecture for classification-based alert correlation, another embodiment is discussed herein as shown in FIG. 7. Since the above-mentioned alert-splitting process is layered, the situation layer and the scenario layer, including a scenario layer C3 and multiple situation layers (C21, C22 . . . ), can be deployed separately. When deploying a large amount of IDS systems, a huge amount of alerts are received but cannot be processed by a single situation layer. Then the architecture of multiple situation layers of the embodiment can be utilized for sharing the alerts amount. Wherein, each of the situation layer (such as C21) receives alerts transmitted from a plurality of intrusion detecting systems (such as C01, C02 . . . ), scenario layer C3 receives the results from multiple situation layers (such as C21, C22 . . . ), and the incident, which is successfully correlated at the scenario layer C3, is transmitted to a head control center C4 for further process. The deployment and the correlation classification architecture of the embodiment can improve the deficiency of the prior art where most alerts are collected in the head control center or a single process layer.

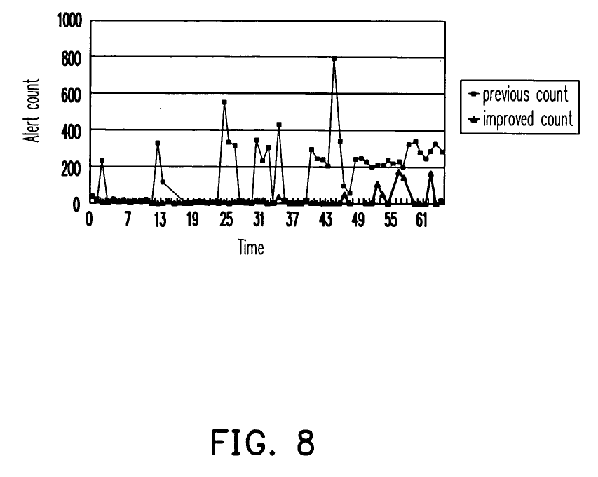

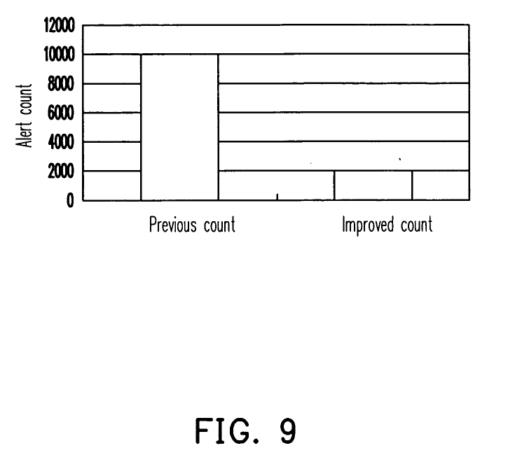

According to the above-mentioned architecture for classification-based alert correlation, another embodiment is described here. The worst time complexity of an attack scenario-oriented correlation method is O(N²), wherein N is an alert gross amount. According to the experiment and relevant research, the situation alerts are generally 80% to 95% of the total alerts. At the minimum rate, suppose situation alerts are only 80%, the time complexity of the scenario layer and the architecture for correlation classification in the embodiment is improved to 4% from the previous rate, or 25 times less. Whereas, the rate between incomplete incident, which can not be correlation-formed, and the alert amount can be approximately improved to 20% of the previous rate, or 5 times less. FIG. 8 schematically shows the comparison of previous alert amount and improved alert amount according to an embodiment of the present invention, and FIG. 9 schematically shows the bar chart of comparison of previous alert amount and improved alert amount according to an embodiment of the present invention.

In summary, the alert-splitting structure is utilized in the method and architecture for classification-based alert correlation of the present invention, thus the more important and complicated alerts can be selected from a huge amount of alerts, and be correlated with known attack scenarios to discover important or large-scale attacks from alerts, thus improving the deficiencies in the conventional technology where all alerts are processed as equals and a lot of computational resources are wasted, many incomplete incidents are created, even the alert correlation are shielded due to over-consumption of computational resources.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A method for on-line classification-based intrusion alert correlation, comprising:
a. splitting a plurality of alerts into a plurality of situation alerts and a plurality of non-situation alerts;
b. correlating the situation alerts matching one of a fan-in situation, a fan-out situation and a focusing situation as a situation-intensive incident, and classifying the remaining situation alerts as residual alerts;
c. correlating the non-situation alerts matching a non-situation attack scenario as a plurality of semi-incidents; and
d. correlating the semi-incidents, the situation-intensive incidents and the residual alerts, and then generating an information security incident if that correlation is successful.

2. The method of claim 1, wherein the situation alerts comprise scanning alerts, flooding alerts and continuous attack alerts.

3. The method of claim 1, wherein the condition of fan-in situation is that among situation alerts with a same target and effect, the amount of distinct sources and the amount of alerts are all over their respective thresholds within a sliding window of time.

4. The method of claim 1, wherein the condition of fan-out situation is that among situation alerts with a same source and effect, the amount of distinct targets and the amount of alerts are all over their respective thresholds within a sliding window of time.

5. The method of claim 1, wherein the condition of focusing situation is that among situation alerts with a same source, target and effect, the amount of alerts are all over a specific threshold within a sliding window of time.

6. The method of claim 1, wherein a non-situation attack scenario is based on a known attack scenario with its situation steps marked as delay correlation.

7. Architecture for on-line classification-based intrusion alert correlation, comprising:
a situation layer, for splitting a plurality of alerts into a plurality of situation alerts and a plurality of non-situation alerts; and
a scenario layer, for saving a plurality of situation correlation results of the situation alerts in a situation layer and the non-situation alerts, further correlating the non-situation alerts matching a same non-situation attack scenario as a same semi-incident, and then correlating the resulted semi-incident with the situation correlation results as an information security incident.

8. The architecture of claim 7, wherein the situation layer comprises:
a splitting device, for splitting the alerts into a plurality of situation alerts and a plurality of non-situation alerts, and transmitting the non-situation alerts to the scenario layer; and
a situation correlation engine, for correlating the situation alerts matching condition of a same fan-in situation, fan-out situation and focusing situation as a same situation-intensive incident, classifying the remaining situation alerts to residual alerts, and transmitting the situation-intensive incident and the residual alerts to the scenario layer.

9. The architecture of claim 7, wherein the scenario layer comprises
a plurality of non-situation attack scenarios, wherein each of non-situation attack scenarios describes non-situation steps of a known attack scenario as a reference of correlating a semi-incident; and
a scenario correlation engine, for correlating the non-situation alerts matching a same non-situation scenario as a same semi-incident, further correlating the resulted semi-incident with the received situation-intensive incident and the residual alerts to form an information security incident if that the correlation is successful.

10. The architecture of claim 7, wherein the situation alerts comprise scanning alerts, flooding alerts and continuous attack alerts.

11. The architecture of claim 8, wherein the condition of a fan-in situation is that among situation alerts with a same target and effect, the amount of distinct sources and the amount of alerts are all over their respective thresholds within a sliding window of time.

12. The architecture of claim 8, wherein the condition of fan-out situation is that among situation alerts with a same source and effect, the amount of distinct targets and the amount of alerts are all over their respective thresholds within a sliding window of time.

13. The architecture of claim 8, wherein the condition of focusing situation is that among situation alerts with a same source, target and effect, the amount of alerts are all over a specific threshold within a sliding window of time.

14. The architecture of claim 7, wherein a non-situation attack scenario is based on a known attack scenario with its situation steps marked as delay correlation.

15. The architecture of claim 8, wherein the situation layer further comprises:
a filter, for filtering a plurality of un-related alerts and incomplete alerts; and
an aggregating device, aggregating a plurality of similar alerts which are received within a short time duration as an alert.

16. The architecture of claim 8, wherein if the situation layer is replaced by multiple situation layers, their relationships comprise:
the non-situation alerts formed by the splitting device of each of the situation layers being sent to the same scenario layer; and
the situation-intensive incidents and the residual alerts resulted by the situation correlation engine of each of the situation layers being sent to the same scenario layer.

17. The architecture of claim 7, wherein the deployment of the situation layer and the scenario layer comprises:
deploying a scenario layer and a situation layer at a same location, and using the scenario layer as security operation center; and
using a scenario layer as a security operation center, and deploying multiple situation layers at various locations.
